(19) United States
(12) Patent Application Publication
(10) Pub. No.: US 2024/0311833 A1
(43) Pub. Date: Sep. 19, 2024

(54) SYSTEMS AND METHODS FOR GENERATING PREDICTIVE OUTCOMES FOR SCENARIOS USING GENERATIVE ARTIFICIAL INTELLIGENCE

(71) Applicant: Wells Fargo Bank, N.A., San Francisco, CA (US)

(72) Inventors: Shuvam Sengupta, Kolkata (IN); Rameshchandra Bhaskar Ketharaju, Hyderabad (IN); Naveen Gururaja Yeri, Bangalore (IN)

(21) Appl. No.: 18/184,174

(22) Filed: Mar. 15, 2023

(51) Int. Cl. G06Q 20/40; G06N 3/0475; G06N 3/094

(52) U.S. Cl. CPC G06Q 20/4016; G06N 3/0475; G06N 3/094

(57) ABSTRACT

Systems, apparatuses, methods, and computer program products are disclosed for generating predictive outcomes for scenarios using generative artificial intelligence. An example method includes receiving first historical customer scenario data and training, by a scenario generator circuitry, a scenario generation model using the first historical customer scenario data and generating an artificial scenario where the artificial scenario includes a node and an edge and where the node is associated with an action and the edge is associated with a decision weight. The example method further includes receiving second historical customer scenario data and training, by a scenario discriminator circuitry, a scenario discrimination model using the second historical customer data. The example method further includes receiving the artificial scenario and determining a scenario discrimination score based on the artificial scenario. The scenario generation model is further trained with the scenario discrimination score and the artificial scenario.

### BACKGROUND

A variety of analytical methods may be used to detect and prevent fraudulent activity with varying rates of success. A major difficulty in detecting fraud, however, remains cases where new types of fraud are practiced, or new platforms and products are rolled out, where the existing analytical methods are not yet able to be trained on large, labelled datasets of fraudulent activity.

### BRIEF SUMMARY

Detecting anomalies for prevention of fraud is an important application of advanced machine learning techniques in the financial services industry. There is an ever-present need to identify fraudulent activities such that measures can be taken to mitigate the effects of such fraud or prevent fraud from occurring in the first place. Fraudulent actions may be linked with certain sets of behaviors or patterns. However, given the constantly evolving nature of fraud, it is imperative to continuously identify these behavior patterns and determine if behaviors of a customer are similar to those identified fraudulent behaviors, which may indicate fraud is occurring.

However, as noted above and given the constantly evolving nature of fraud, difficulty arises in detecting and preventing new forms of fraud that have not been possible to study previously. New forms of fraud may arise from new scenarios invented by fraudsters, or may especially impact new products and platforms that may have potentially untested vulnerabilities. Existing techniques thus have a “cold start” period where new types of fraud must be learned quickly to protect against fraudulent behaviors, which creates a period of high risk.

In contrast to these conventional techniques for fraud detection, example embodiments described herein use generative artificial intelligence (GAI) to generate predictive scenarios and evaluate the potential for fraud. GAI may be used to create artificial scenarios, after being trained on historical customer data, which may be legitimate or fraudulent. A discriminator network counterpart of the GAI model may attempt to classify these artificial scenarios in various ways, detecting their legitimacy and/or resemblance to real-life scenarios. The results of the discriminator network may be passed back to the GAI to refine and improve the GAI ability to generate new artificial scenarios. The entire process may thus produce results that point out new types of fraudulent activity and the risk associated with various actions around these new types of fraud.

Accordingly, the present disclosure sets forth systems, methods, and apparatuses that advance (i.e., improve) fraud prevention and anomaly detection within the technical fields of cyber and data security and electronic transactions. Example embodiments disclosed herein thus enable new technological advances in machine learning, and GAI in particular, to provide benefits to institutions that need to prevent fraudulent activity. Additionally, example embodiments further improve the technical fields of cyber and data security and electronic transactions by providing improvements to existing methods of anomaly detection by generating a wider variety of scenarios to be used as a training dataset. Furthermore, example embodiments may reduce the risk associated with rolling out new products and services, reducing the cost of innovation by accelerating the process of studying new types of fraudulent activity and other day-one exploits associated with new products and services.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used to generate predictive outcomes for scenarios using GAI.

FIG. 2 illustrates a schematic block diagram of example circuitry embodying a device that may perform various operations in accordance with some example embodiments described herein.

FIG. 3 illustrates an example flowchart for generating artificial scenarios that may be used to generate predictive outcomes, in accordance with some example embodiments described herein.

FIG. 4 illustrates an example flowchart for discriminating artificial scenarios that may be used to generate predictive outcomes, in accordance with some example embodiments described herein.

FIG. 5 illustrates a swim lane diagram with example operations that may be performed by components of the environment depicted in FIG. 1, in accordance with some example embodiments described herein.

FIG. 6 illustrates an example artificial scenario with a node and edge structure, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

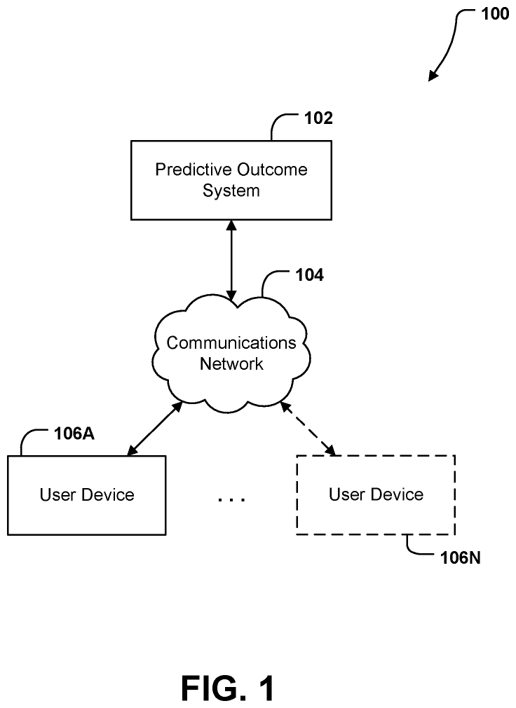

Example embodiments described herein may be implemented using any of a variety of computing devices or servers. To this end, FIG. 1 illustrates an example environment 100 within which various embodiments may operate. As illustrated, a predictive outcome system 102 may receive and/or transmit information via communications network 104 (e.g., the Internet) with any number of other devices, such as one or more of user devices 106A-106N.

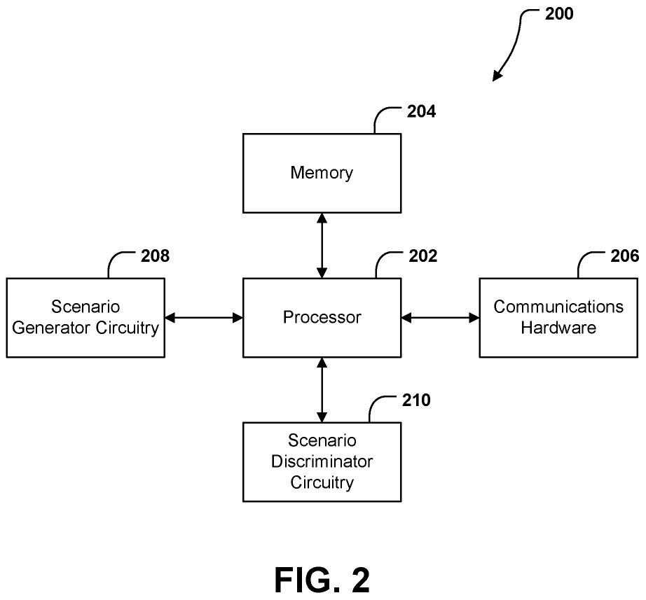

The predictive outcome system 102 may be implemented as one or more computing devices or servers, which may be composed of a series of components. Particular components of the predictive outcome system 102 are described in greater detail below with reference to apparatus 200 in connection with FIG. 2.

The one or more user devices 106A-106N may be embodied by any computing devices known in the art, such as desktop or laptop computers, tablet devices, smartphones, or the like. The one or more user devices 106A-106N need not themselves be independent devices, but may be peripheral devices communicatively coupled to other computing devices.

Although FIG. 1 illustrates an environment and implementation in which the predictive outcome system interacts with one or more of user devices 106A through 106N, in some embodiments users may directly interact with the predictive outcome system (e.g., via input/output circuitry of the predictive outcome system 102), in which case a separate user device (e.g., any of the user devices 106A through 106N) may not be utilized. Whether by way of direct interaction or via the separate user device, a user may communicate with, operate, control, modify, or otherwise interact with the predictive outcome system to perform the various functions and achieve the various benefits described herein.

### Example Implementing Apparatuses

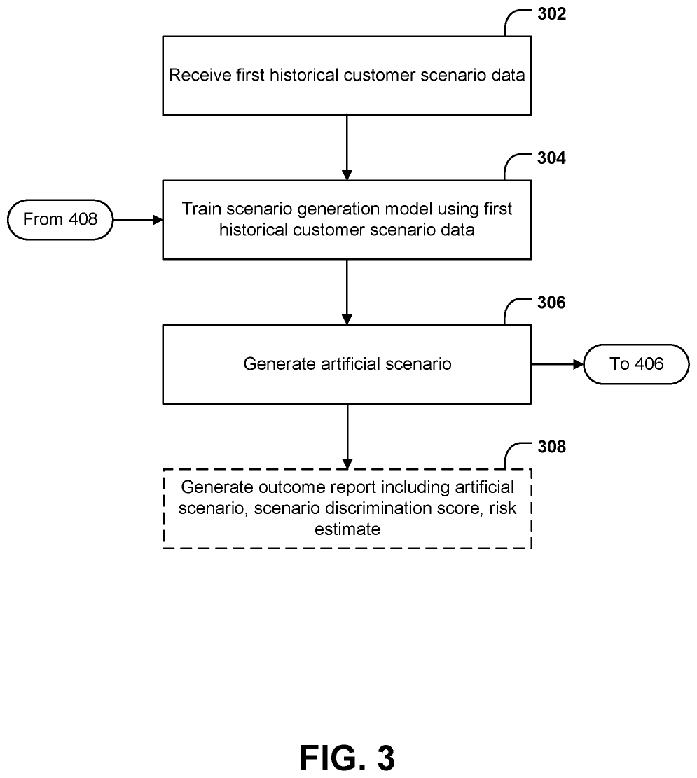

The predictive outcome system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-5. As illustrated in FIG. 2, the apparatus 200 may include processor 202, memory 204, communications hardware 206, scenario generator circuitry 208, and scenario discriminator circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

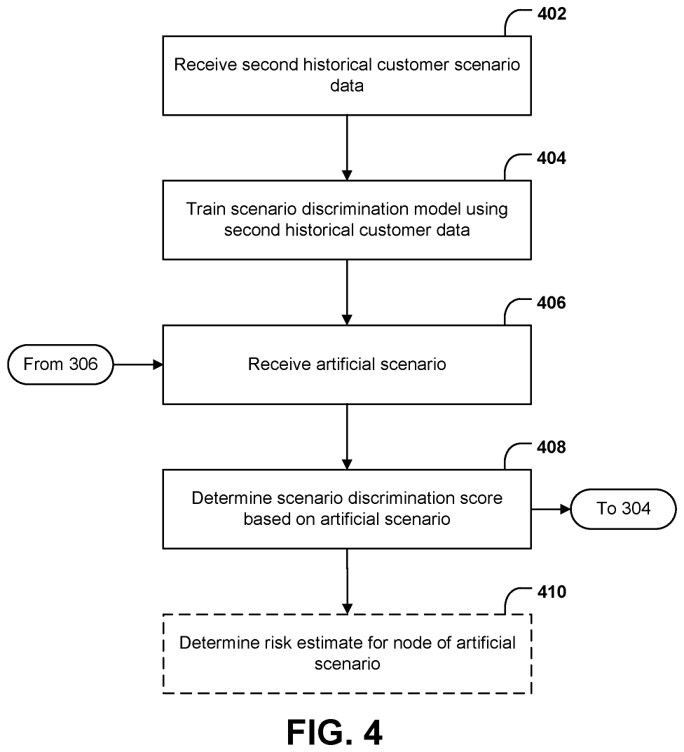

In addition, the apparatus 200 further comprises a scenario generator circuitry 208 that generates artificial scenarios. The scenario generator circuitry 208 may utilize processor 202, memory 204, or any other hardware component included in the apparatus 200 to perform these operations, as described in connection with FIGS. 3-4 below. The scenario generator circuitry 208 may further utilize communications hardware 206 to gather data from a variety of sources and/or exchange data with a user, and in some embodiments may utilize processor 202 and/or memory 204 to generate artificial scenarios.

In addition, the apparatus 200 further comprises a scenario discriminator circuitry 210 that assigns a scenario discrimination score to artificial scenarios. The scenario discriminator circuitry 210 may utilize processor 202, memory 204, or any other hardware component included in the apparatus 200 to perform these operations, as described in connection with FIGS. 3-4 below. The scenario discriminator circuitry 210 may further utilize communications hardware 206 to gather data from a variety of sources, and/or exchange data with a user, and in some embodiments may utilize processor 202 and/or memory 204 to assign scenario discrimination scores.

Although components 202-210 are described in part using functional language, it will be understood that the particular implementations necessarily include the use of particular hardware. It should also be understood that certain of these components 202-210 may include similar or common hardware. For example, the scenario generator circuitry 208 and scenario discriminator circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the scenario generator circuitry 208 and scenario discriminator circuitry 210 may leverage processor 202, memory 204, or communications hardware 206 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, or communications hardware 206 for enabling any functions not performed by special-purpose hardware elements. In all embodiments, however, it will be understood that the scenario generator circuitry 208 and scenario discriminator circuitry 210 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third-party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

Turning to FIGS. 3 and 4, example flowcharts are illustrated that contain example operations implemented by example embodiments described herein. The operations illustrated in FIGS. 3 and 4 may, for example, be performed by the predictive outcome system shown 102 in FIG. 1, which may in turn be embodied by an apparatus 200, which is shown and described in connection with FIG. 2. To perform the operations described below, the apparatus 200 may utilize one or more of processor 202, memory 204, communications hardware 206, scenario generator circuitry 208, scenario discriminator circuitry 210, and/or any combination thereof. It will be understood that user interaction with the predictive outcome system may occur directly via communications hardware 206, or may instead be facilitated by a separate user device (e.g., any one of the user devices 106A through 106N), as shown in FIG. 1, and which may have similar or equivalent physical componentry facilitating such user interaction.

Turning first to FIG. 3, example operations are shown for generating artificial scenarios that may be used to generate predictive outcomes. As shown by operation 302, the apparatus 200 includes means, such as processor 202, memory 204, communications hardware 206, scenario generator circuitry 208, or the like, for receiving first historical customer scenario data. The customer scenario data may be data related to activities of one or more individuals who may be customers, users, or others. The scenario data may relate to interactions with an organization, non-limiting examples of which include purchases, deposits, withdrawals, customer service actions, and requests for and/or transactions of user data. Scenario data may relate to interactions performed online, in person, via telephone, or by any other medium. The historical customer scenario may also include data related to impacts of various customer interactions such monetary gains or losses. The details of the customer interactions may be structured data in a list, with each interaction including a plurality of data features (e.g., type of interaction, value of transaction, or time and date, etc.). The features included may vary between data entries such that, in some embodiments, the same feature set may be present for the entire dataset and in some embodiments, the feature set may vary across the dataset. In some embodiments, the historical customer scenario data may be artificial, either generated by the predictive outcome system 102 or another system, and in some embodiments the historical customer scenario data may be data from real interactions with customers or other users.

The communications hardware 206 may receive the first historical customer scenario data using network hardware (e.g., via communications network 104) and subsequently transmit the first historical customer scenario data to the scenario generator circuitry 208 (e.g., via a bus), or in some embodiments, the first historical customer scenario data may be retrieved from non-volatile memory 204 and transmitted to scenario generator circuitry 208. Irrespective of the origin of the first historical customer scenario data, the scenario generator circuitry 208 may receive the first historical customer scenario data such that it is available for processing, training, subsequent storage, or other activities utilizing the scenario generator circuitry 208.

As shown by operation 304, the apparatus 200 includes means, such as processor 202, memory 204, communications hardware 206, scenario generator circuitry 208, or the like, for training a scenario generation model using the first historical customer scenario data. The scenario generator circuitry 208 may train the scenario generation model by fitting the internal parameters of the scenario generation model to the data of the first historical customer scenario data. In some embodiments, the scenario generator circuitry 208 may clean, format, infill, or otherwise prepare the first historical customer scenario data for training. The scenario generator circuitry 208 may be configured to train the scenario generation model using supervised and/or unsupervised learning, may use a hybrid of both approaches, or may use training approaches with reduced levels of user supervision. The scenario generator circuitry 208 may use the entire dataset of the first historical customer scenario data, or may be configured to divide the data for providing diagnostics, to control for overtraining, or for other reasons. In some embodiments, the scenarios of the first historical customer scenario data may be interpreted and formatted using the edge and node structure described below in connection with operation 306. In some embodiments, the first historical customer scenario data may also include one or more scenario discrimination scores (described below in connection with operation 408) based on an artificial scenario.

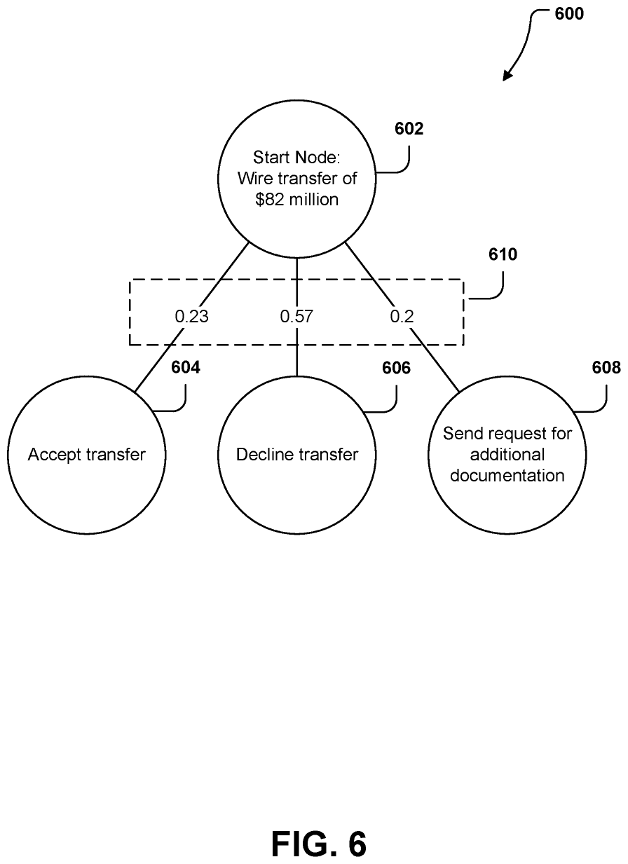

As shown by operation 306, the apparatus 200 includes means, such as processor 202, memory 204, communications hardware 206, scenario generator circuitry 208, or the like, for generating an artificial scenario, where the artificial scenario includes a node and an edge, where the node is associated with an action and the edge is associated with a decision weight. The scenario generator circuitry 208 may generate an artificial scenario using the scenario generation model that has been trained on historical customer scenario data. The artificial scenario may be structured as one or more edges and one or more nodes, as depicted in FIG. 6. The scenario generator circuitry 208 may use the trained model, which may be trained as shown in connection with operation 304, to generate the artificial scenario. The scenario generator circuitry 208 may generate the artificial scenario by providing a random or pseudo-random seed to the scenario generation model, which may be drawn from a pre-determined probability distribution. The scenario generation model may map the randomized input into a particular artificial scenario based on the training of the scenario generation model.

In particular, turning now to FIG. 6, a simple example artificial scenario 600 is shown with a start node 602 labeled “wire transfer of $82 million.” Three edges 610 may each have a numerical weight associated, which may relate to the risk of decisions connected to each edge, the probability or weight of each decision associated with the edge, or other weighting schemes. The three edges 610 connect to respective ones of three subsequent leaf nodes: the first node 604 labeled “accept transfer”, the second node 606 labeled “decline transfer,” and the third node 608 labeled “send request for additional documentation.” The leaf nodes (i.e., first node 604 through third node 608 represent branching decision paths in the artificial scenario. In some embodiments, such nodes may have additional edges and further leaf nodes branching out from the start node 602 and/or any of the existing leaf nodes (i.e., first node 604 through third node 608). For example, the third node 608 may have subsequent edges connecting to additional leaf nodes that relate to actions taken in response by a customer after a request for additional documentation is provided.

In some embodiments, the artificial scenario also includes one or more starting conditions including a credit score, a physical location, a debt-to-income ratio, a transaction amount, and an interest rate. The starting conditions may be specified as part of the starting node (e.g., such as start node 602) or may be separate node connected to the starting nodes. The starting conditions may further specify the artificial scenario and impact the weights associated with the artificial scenario edges. The starting conditions may be financial data, such as a credit score or debt-to-income ratio, physical characteristics such as a physical location, or details of an action such as a transaction amount or interest rate associated with a loan or deposit account.

Turning next to FIG. 4, example operations are shown for discriminating artificial scenarios that may be used to generate predictive outcomes. As shown by operation 402, the apparatus 200 includes means, such as processor 202, memory 204, communications hardware 206, scenario discriminator circuitry 210, or the like, for receiving second historical customer scenario data. The customer scenario data may be data related to activities of one or more individuals who may be customers, users, or others. The scenario data may relate to interactions with an organization, non-limiting examples of which include purchases, deposits, withdrawals, customer service actions, and requests for and/or transactions of user data. Scenario data may relate to interactions performed online, in person, via telephone, or by any other medium. The historical customer scenario may also include data related to impacts of various customer interactions such monetary gains or losses. The details of the customer interactions may be structured data in a list, with each interaction including a plurality of data features (e.g., type of interaction, value of transaction, or time and date, etc.). The features included may vary between data entries such that, in some embodiments, the same feature set may be present for the entire dataset and in some embodiments, the feature set may vary across the dataset. In some embodiments, the historical customer scenario data may be artificial, either generated by the predictive outcome system 102 or another system, and in some embodiments the historical customer scenario data may be data from real interactions with customers or other users.

The communications hardware 206 may receive the second historical customer scenario data using network hardware (e.g., via communications network 104) and subsequently transmit the second historical customer scenario data to the scenario discriminator circuitry 210 (e.g., via a bus), or in some embodiments, the second historical customer scenario data may be retrieved from non-volatile memory 204 and transmitted to scenario discriminator circuitry 210. Irrespective of the origin of the second historical customer scenario data, the scenario discriminator circuitry 210 may receive the second historical customer scenario data such that it is available for processing, training, subsequent storage, or other activities utilizing the scenario discriminator circuitry 210.

In some embodiments, the first historical customer scenario data and the second historical customer scenario data are different. For example, the predictive outcome system 102 may be configured to generate artificial scenarios with a first data set and discriminate the artificial scenarios using the second data set. In some embodiments, the second historical customer scenario data may include artificial data from previous configurations of the predictive outcome system 102, while the first historical customer scenario data may not include artificial scenarios. In some embodiments, the first historical customer scenario data and the second historical customer scenario data are identical. The first historical customer scenario data and the second historical customer scenario data may be the same, for example, in the initial stages of training if no additional artificial scenario data has been added to the datasets.

In some embodiments, the second historical customer scenario data includes transactions labeled as fraudulent or non-fraudulent. For example, in an instance in which the scenario discriminator circuitry 210 trains the scenario discrimination model using a supervised or semi-supervised learning approach, the data may be labeled. The labeling may be based on customer feedback, for example, if a customer flags a transaction in a user account as being fraudulent. The labeling may also be provided by experts, who may review the dataset and determine if various scenarios are fraudulent or non-fraudulent. In some embodiments, the second historical customer scenario data may be structured using the node and edge data structure of FIG. 6, and only certain nodes may be labeled as fraudulent or non-fraudulent. In some embodiments, a numerical weight may be assigned to indicate whether an activity is fraudulent or non-fraudulent, for example, larger negative weights may indicate a significant and/or costly fraudulent activity, where large positive weights indicate a beneficial and/or profitable legitimate activity.

As shown by operation 404, the apparatus 200 includes means, such as processor 202, memory 204, communications hardware 206, scenario discriminator circuitry 210, or the like, for training a scenario discrimination model using the second historical customer data. The scenario discriminator circuitry 210 may train the scenario discrimination model by fitting the internal parameters of the scenario generation model to the data of the second historical customer scenario data. In some embodiments, the scenario discriminator circuitry 210 may clean, format, infill, or otherwise prepare the second historical customer scenario data for training. The scenario discriminator circuitry 210 may be configured to train the scenario discrimination model using supervised and/or unsupervised learning, may use a hybrid of both approaches, or may use training approaches with reduced levels of user supervision. The scenario discriminator circuitry 210 may use the entire dataset of the second historical customer scenario data, or may be configured to divide the data for providing diagnostics, to control for overtraining, or for other reasons. In some embodiments, the scenarios of the second historical customer scenario data may be interpreted and formatted using the edge and node structure described previously in connection with operation 306.

As shown by operation 406, the apparatus 200 includes means, such as processor 202, memory 204, communications hardware 206, scenario generator circuitry 208, scenario discriminator circuitry 210, or the like, for receiving the artificial scenario. The scenario discriminator circuitry 210 may receive the artificial scenario directly from the scenario generator circuitry 208 (e.g., via a bus). As shown in FIGS. 3-4, the artificial scenario may be generated in operation 306 and transmitted directly to the scenario discriminator circuitry 210. In some embodiments, the communications hardware 206 may receive the second historical customer scenario data using network hardware (e.g., via communications network 104) and subsequently transmit the artificial scenario to the scenario discriminator circuitry 210 (e.g., via a bus), or in some embodiments, the artificial scenario may be retrieved from non-volatile memory 204 and transmitted to scenario discriminator circuitry 210. Irrespective of the origin of the received artificial scenario, the scenario discriminator circuitry 210 may receive artificial scenario such that it is available for classification, subsequent storage, or other activities utilizing the scenario discriminator circuitry 210.

As shown by operation 408, the apparatus 200 includes means, such as processor 202, memory 204, communications hardware 206, scenario discriminator circuitry 210, or the like, for determining a scenario discrimination score based on the artificial scenario, where the scenario generation model is further trained with the scenario discrimination score and the artificial scenario. The scenario discriminator circuitry 210 may process the artificial scenario received during operation 406, and use the scenario discrimination model to determine a scenario discrimination score. The scenario discrimination score may provide an estimate for classifying the artificial scenario into one or more categories. For example, the scenario discriminator circuitry 210 may be configured so that the scenario discrimination score may attempt to classify the artificial scenario as real or artificial, which may cause the predictive outcome system 102 to generate more realistic artificial scenarios. In some embodiments, the scenario discrimination score is related to a probability of fraudulent activity. In this configuration, for example, the predictive outcome system 102 may be able to both generate and detect more example fraudulent scenarios based on data of the artificial scenario. During operation, the configuration of the scenario discrimination may change to meet different goals and tune the training of the predictive outcome system 102. For example, an initial stage may target training more realistic artificial scenarios, then subsequently the predictive outcome system 102 may be reconfigured to generate more realistic fraudulent artificial scenarios.

As shown by operation 410, the apparatus 200 may include means, such as processor 202, memory 204, communications hardware 206, scenario discriminator circuitry 210, or the like, for determining a risk estimate for the node of the artificial scenario. The scenario discriminator circuitry 210 may determine the risk estimate for one or more nodes based on the weights and/or risk values associated with edges of the artificial scenario. For example, an artificial scenario may include a decision chain (e.g., request for wire transfer, request additional verification documents, provide identification document, verify identification document) where the edges along the decision chain may each accumulate an amount of risk. The scenario discriminator circuitry 210 may aggregate the estimates of risk to find a total risk estimate associated with a leaf, or terminal node in the decision chain. The risk estimate may be further associated to the artificial scenario, and may be used for subsequent training and/or for reporting (such as the outcome report described in connection with operation 308 below).

In some embodiments, the scenario generation model and the scenario discrimination model are neural networks. In some embodiments, either the scenario generation model or the scenario discrimination model is a neural network, while one model may be a different machine learning model. In some embodiments, the scenario generation model may be any generative machine learning model, and the scenario discrimination model may be any discriminative machine learning model. In an instance in which the predictive outcome system 102 is configured so that one of the models is a neural network, the hyperparameters of the neural network, such as the number of layers, number of nodes per layer, activation functions, and other hyperparameters of the neural network may be configured.

In some embodiments, the scenario generation model and the scenario discrimination model may be part of a scenario outcome prediction generative adversarial network (also referred to herein as “scenario output prediction GAN”) that also includes an objective function. The objective function may be based on a difference between the second historical customer scenario data and a set of generated scenarios comprising the artificial scenario. The objective function may depend on the similarity of the artificial scenario to the first historical customer scenario data and/or the similarity of the artificial scenario to the second historical customer scenario data. The objective function may further depend on the scenario discrimination scores produced by the scenario discrimination model for different inputs (e.g., artificial scenarios and scenarios from the second historical customer scenario data).

In some embodiments, the scenario outcome prediction GAN may cause the scenario generation model to minimize the objective function and the scenario discrimination model to maximize the objective function. The scenario generation model and the scenario discrimination model may attempt to achieve opposite effects by maximizing or minimizing the objective function, as part of the structure of the scenario outcome prediction GAN. The scenario outcome prediction GAN may reach an equilibrium value of the objective function (e.g., a Nash equilibrium). In some embodiments, the scenario outcome prediction GAN may not reach a stable equilibrium value, but may proceed until a user interrupts the predictive outcome system 102 and stops the operation.

The scenario outcome prediction GAN, in the course of operating and minimizing the objective function, may pass control and data to and from various circuitry. For example, as shown in FIGS. 3 and 4, the artificial scenario generated in connection with operation 306 may be received in operation 406 by the scenario discriminator circuitry. The scenario discrimination score determined in operation 408, for example, may be received by the scenario generation circuitry in operation 304 as part of the first historical customer scenario data, and used to train the scenario generation model.

Returning to FIG. 3, as shown by operation 308, the apparatus 200 may include means, such as processor 202, memory 204, communications hardware 206, scenario generator circuitry 208, scenario discriminator circuitry 210, or the like, for generating an outcome report including the artificial scenario, the scenario discrimination score, and the risk estimate. The communications hardware 206 may prepare the outcome report during the operation of the predictive outcome system 102, or after the predictive outcome system 102 stops, for example, due to a user interruption or the system reaching an equilibrium state. The outcome report may be generated based on one or more artificial scenarios generated by the scenario generator circuitry 208, one or more scenario discrimination scores generated by the scenario discriminator circuitry 210, and/or the risk estimate generated by the scenario discriminator circuitry 210. The outcome report may be displayed using any of the attached peripheral devices of communications hardware 206, or may be transmitted via network hardware of the communications hardware 206 to one of the user devices 106A through 106N. Additionally or alternatively, the outcome report may be stored (e.g., with volatile or non-volatile memory 204) for later retrieval.

FIGS. 3 and 4 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

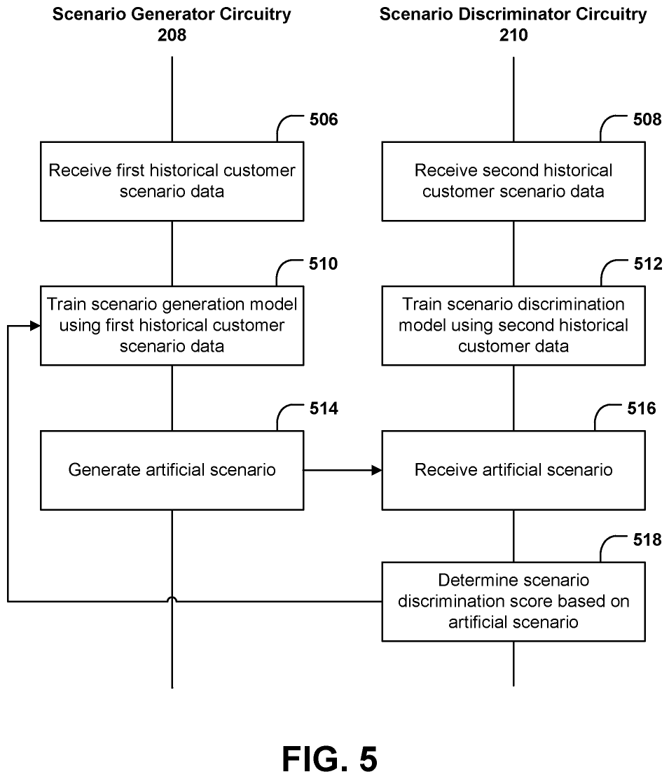

FIG. 5 shows a swim lane diagram illustrating example operations (e.g., as described above in connection with FIGS. 3 and 4) performed by components of the environment depicted in FIG. 1 to produce various benefits of the implementations described herein. The operations shown in the swim lane diagram performed by the scenario generator circuitry 208 are shown along the line extending from the “scenario generator circuitry 208” label and operations performed by a scenario discriminator circuitry 210 are shown along the line extending from the “scenario discriminator circuitry 210” label shown in FIG. 5. Operations impacting multiple devices, such as data transmissions between the devices, are shown using arrows extending between these lines. Generally, these operations are ordered temporally with respect to one another. However, it will be appreciated that the operations may be performed in other orders from those illustrated in FIG. 5.

Operations 506, 510, 514, 508, 512, 516 and 518 of FIG. 5 correspond to operations 302, 304, 306, 402, 404, 406, 408, respectively. In particular, at operation 506 and as discussed above in reference to operation 302 of FIG. 3, the scenario generator circuitry may receive the first historical customer scenario data. At operation 508 and as discussed above in reference to operation 402 of FIG. 4, the scenario discriminator circuitry may receive the second historical customer scenario data. At operation 510 and as discussed above in reference to operation 304 of FIG. 3, the scenario generator circuitry may train the scenario generation model using the first historical customer scenario data At operation 512 and as discussed above in reference to operation 404 of FIG. 4, the scenario discriminator circuitry may train the scenario discrimination model using the second historical customer scenario data. At operation 514 and as discussed above in reference to operation 306 of FIG. 3, the scenario generator circuitry may generate the artificial scenario, and the artificial scenario may be transmitted to the scenario discriminator circuitry. At operation 516 and as discussed above in reference to operation 406 of FIG. 4, the scenario discriminator circuitry may receive the artificial scenario. At operation 518 and as discussed above in reference to operation 408 of FIG. 4, the scenario discriminator circuitry may determine a scenario discrimination score based on the artificial scenario. The scenario discrimination score may, in some embodiments, be transmitted to the scenario generator circuitry, and used to train the scenario generation model.

In some embodiments, some of the operations described above in connection with FIGS. 3-5 may be modified or further amplified. Furthermore, in some embodiments, additional optional operations may be included. Modifications, amplifications, or additions to the operations above may be performed in any order and in any combination.

### Conclusion

As described above, example embodiments provide methods and apparatuses that enable improved anomaly detection and generate improved predictive outcomes for scenarios. A scenario generation circuitry trained on historical customer data generates artificial scenarios which may lead to advance detection of new fraudulent schemes. The generated artificial scenarios utilize a graph structure to capture the decisions and risk factors associated with each decision, enabling easy interpretation by human operators. The scenario discriminator circuitry, also trained on historical customer data, attempts to discern between beneficial and fraudulent activity and/or real and artificial activity. The scenario discriminator circuitry may provide stronger anomaly detection power due to its connection to the scenario generator circuitry.

As these examples all illustrate, example embodiments contemplated herein provide technical solutions that solve real-world problems faced during fraud prevention. And while fraud has been an issue for decades, the recently exploding amount of data made available by recently emerging technology today has made this problem significantly more acute, as types of fraudulent activities that must be guarded against has expanded due to the increased number of services provided, allowing more potential vectors for attack. At the same time, the recently arising ubiquity of generative artificial intelligence has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by scenario generator circuitry of a predictive outcome system, first historical customer scenario data;
training, by the scenario generator circuitry, a scenario generation model using the first historical customer scenario data;
generating, by the scenario generator circuitry and using the scenario generation model, an artificial scenario, wherein the artificial scenario comprises a node and an edge, wherein the node is associated with an action and the edge is associated with a decision weight;
receiving, by scenario discriminator circuitry of the predictive outcome system, second historical customer scenario data;
training, by the scenario discriminator circuitry, a scenario discrimination model using the second historical customer scenario data;
receiving, by the scenario discriminator circuitry, the artificial scenario; and
determining, by the scenario discriminator circuitry and using the scenario discrimination model, a scenario discrimination score based on the artificial scenario, wherein the scenario generation model is further trained with the scenario discrimination score and the artificial scenario.

2. The method of claim 1, wherein the second historical customer scenario data comprises transactions labeled as fraudulent or non-fraudulent.

3. The method of claim 1, further comprising:
determining, by the scenario discriminator circuitry, a risk estimate for the node of the artificial scenario.

4. The method of claim 3, further comprising:
generating, by communications hardware, an outcome report comprising the artificial scenario, the scenario discrimination score, and the risk estimate.

5. The method of claim 1, wherein the scenario discrimination score is related to a probability of fraudulent activity.

6. The method of claim 1, wherein the artificial scenario further comprises one or more starting conditions comprising a credit score, a physical location, a debt-to-income ratio, a transaction amount, and an interest rate.

7. The method of claim 1, wherein:
the scenario generation model and the scenario discrimination model are neural networks; and
the scenario generation model and the scenario discrimination model are part of a scenario outcome prediction generative adversarial network (scenario outcome prediction GAN) that further comprises an objective function, wherein the objective function is based on a difference between the second historical customer scenario data and a set of generated scenarios comprising the artificial scenario.

8. The method of claim 7, wherein the scenario outcome prediction GAN causes the scenario generation model to minimize the objective function and the scenario discrimination model to maximize the objective function.

9. The method of claim 1 wherein the first historical customer scenario data and the second historical customer scenario data are different.

10. The method of claim 1 wherein the first historical customer scenario data and the second historical customer scenario data are identical.

11. An apparatus comprising:
scenario generator circuitry of a predictive outcome system configured to:
receive first historical customer scenario data,
train a scenario generation model using the first historical customer scenario data, and
generate, using the scenario generation model, an artificial scenario, wherein the artificial scenario comprises a node and an edge, wherein the node is associated with an action and the edge is associated with a decision weight; and
scenario discriminator circuitry of the predictive outcome system configured to:
receive second historical customer scenario data,
train a scenario discrimination model using the second historical customer scenario data,
receive the artificial scenario, and
determine, using the scenario discrimination model, a scenario discrimination score based on the artificial scenario, wherein the scenario generation model is further trained with the scenario discrimination score and the artificial scenario.

12. The apparatus of claim 11, wherein the second historical customer scenario data comprises transactions labeled as fraudulent or non-fraudulent.

13. The apparatus of claim 11, wherein the scenario discriminator circuitry is further configured to determine a risk estimate for the node of the artificial scenario.

14. The apparatus of claim 13, further comprising communications hardware configured to generate an outcome report comprising the artificial scenario, the scenario discrimination score, and the risk estimate.

15. The apparatus of claim 11, wherein the scenario discrimination score is related to a probability of fraudulent activity.

16. The apparatus of claim 11, wherein the artificial scenario further comprises one or more starting conditions comprising a credit score, a physical location, a debt-to-income ratio, a transaction amount, and an interest rate.

17. The apparatus of claim 11, wherein:
the scenario generation model and the scenario discrimination model are neural networks; and
the scenario generation model and the scenario discrimination model are part of a scenario outcome prediction generative adversarial network (scenario output prediction GAN) that further comprises an objective function, wherein the objective function is based on a difference between the second historical customer scenario data and a set of generated scenarios comprising the artificial scenario.

18. The apparatus of claim 17, wherein the scenario outcome prediction GAN causes the scenario generation model to minimize the objective function and the scenario discrimination model to maximize the objective function.

19. The apparatus of claim 11 wherein the first historical customer scenario data and the second historical customer scenario data are different.

20. A computer program product comprising at least one non-transitory computer-readable storage medium storing software instructions that, when executed, cause an apparatus to:
receive first historical customer scenario data;
train a scenario generation model using the first historical customer scenario data;
generate, using the scenario generation model, an artificial scenario, wherein the artificial scenario comprises a node and an edge, wherein the node is associated with an action and the edge is associated with a decision weight;
receive second historical customer scenario data;
train a scenario discrimination model using the second historical customer scenario data;
receive the artificial scenario; and
determine, using the scenario discrimination model, a scenario discrimination score based on the artificial scenario, wherein the scenario generation model is further trained with the scenario discrimination score and the artificial scenario.
